(19) United States
(12) Patent Application Publication
(10) Pub. No.: US 2021/0011585 A1
(43) Pub. Date: Jan. 14, 2021

(54) MENU DISPLAY METHOD, APPARATUS, DEVICE AND STORAGE MEDIUM

(71) Applicant: BEIJING BYTEDANCE NETWORK TECHNOLOGY CO., LTD., Beijing (CN)

(72) Inventor: Wei JI, Beijing (CN)

(21) Appl. No.: 17/017,855

(22) Filed: Sep. 11, 2020

Related U.S. Application Data
(63) Continuation of application No. PCT/CN2019/117162, filed on Nov. 11, 2019.

(30) Foreign Application Priority Data
Nov. 16, 2018 (CN) 201811372046.0

(51) Int. Cl. G06F 3/0482; G06F 3/0484; G06F 3/0488

(52) U.S. Cl. CPC G06F 3/0482; G06F 2203/04808; G06F 3/0488; G06F 3/04845

(57) ABSTRACT

The embodiments of the present disclosure disclose a menu display method, apparatus, device and storage medium. The menu display method includes: displaying a text selection menu according to current display location information of a text content on a screen when a selection operation for the text content in a current view control is detected; acquiring the final display location information of the text content on the screen after a sliding operation completes, in response to detecting the sliding operation for the view control; and redisplaying the text selection menu according to the final display location information. The embodiments of the present disclosure can improve the interactivity of the text selection menu

### CROSS-REFERENCE TO RELATED APPLICATION

The present disclosure is a continuation of PCT International Application No. PCT/CN2019/117162, filed on Nov. 11, 2019, which claims priority of a Chinese patent application No. 201811372046.0, filed on Nov. 16, 2018 in the China National Intellectual Property Administration, the disclosure of which is incorporated by reference herein in its entirety.

### TECHNICAL FIELD

The embodiments of the present disclosure relate to computer technology, and in particular, to a menu display method, apparatus, device, and storage medium.

### BACKGROUND ART

With the continuous development of computer technology, users have higher demands for the interactivity of smart devices.

In Android 6.0, after the user selects a piece of text content by touching the screen, a floating text selection menu is displayed around the selected text content. The text selection menu includes options such as copy, paste, forward, and the like, and the corresponding function can be realized by clicking on an option by user. Through the floating text selection menu, the interactive friendliness of the text selection operation is greatly improved.

However, in the prior art, after the user selects a piece of text content and the text selection menu is displayed, if the view control where the selected text content is located slides due to the reason such as user misoperation and the like, the displayed text selection menu will disappear, thereby reducing the interactivity of the text selection menu.

### SUMMARY OF THE INVENTION

In a first aspect, embodiments of the present disclosure provide a menu display method, including: displaying a text selection menu according to current display location information of a text content on a screen when a selection operation for the text content in a current view control is detected; acquiring the final display location information of the text content on the screen after a sliding operation completes, in response to detecting the sliding operation for the view control; and redisplaying the text selection menu according to the final display location information.

In a second aspect, embodiments of the present disclosure also provide a menu display apparatus, including:

a text content selection module configured to display a text selection menu according to current display location information of a text content on a screen when a selection operation for the text content in a current view control is detected;

a final location acquiring module configured to obtain the final display location information of the text content on the screen after a sliding operation completes, in response to detecting the sliding operation for the view control; and

a menu redisplay module configured to redisplay the text selection menu according to the final display location information.

In a third aspect, embodiments of the present disclosure also provide a terminal device, which includes:

one or more processors;

a memory configured to store one or more programs,

the one or more programs are executed by the one or more processors, so that the one or more processors implement the menu display method according to any one of the embodiments of the present disclosure.

In a fourth aspect, the embodiment of the present disclosure also provides a computer-readable storage medium storing computer program, where the computer program, when being executed by a processor, causes to implement the menu display method according to any one of the embodiments of the present disclosure.

### THE DESCRIPTION OF DRAWINGS

FIG. 1 is a schematic flowchart of a menu display method provided in one or more embodiments of the present disclosure;

FIG. 2a is a schematic flowchart of a menu display method provided in one or more embodiments of the present disclosure;

FIG. 2b is a schematic diagram of a WebView control-based interface display before sliding applicable to one or more embodiments of the present disclosure;

FIG. 2c is a schematic diagram of a WebView control-based interface display after sliding applicable to one or more embodiments of the present disclosure;

FIG. 3a is a schematic flowchart of a menu display method provided in one or more embodiments of the present disclosure;

FIG. 3b is a schematic diagram of a TextView control-based interface display before sliding applicable to one or more embodiments of the present disclosure;

FIG. 3c is a schematic diagram of a TextView control-based interface display after sliding upward applicable to one or more embodiments of the present disclosure;

FIG. 3d is a schematic diagram of a TextView control-based interface display after sliding downward applicable to one or more embodiments of the present disclosure;

FIG. 4 is a schematic structural diagram of a menu display apparatus provided in one or more embodiments of the present disclosure; and

FIG. 5 is a schematic diagram of a hardware structure of a terminal device provided in one or more embodiments of the present disclosure.

### DETAILED DESCRIPTION OF THE PREFERRED EMBODIMENT

The present disclosure will be further described in detail below in conjunction with the drawings and embodiments. It can be understood that the specific embodiments described here are only used to explain the present disclosure, but not to limit the present disclosure. In addition, it should be noted that, for ease of description, only a part of the structure related to the present disclosure is shown in the accompanying drawings instead of all of the structure.

In the following embodiments, each embodiment provides optional features and examples at the same time. The various features recorded in the embodiments can be combined to form multiple alternative solutions, and each numbered embodiment should not be regarded as only one technical solution.

### Embodiment 1

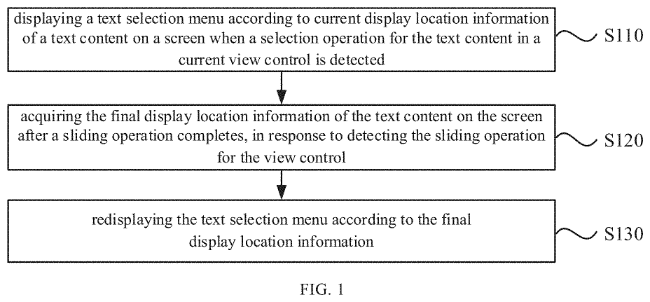

FIG. 1 is a schematic flowchart of a menu display method provided in one or more embodiments of the present disclosure. This method can be applied to the situation where the text selection menu is displayed after the location of the selected text content is changed. The method can be executed by a menu display apparatus, which can be composed of hardware and/or software, and can generally be integrated in mobile phones, tablets, and in all terminal devices that include text content selection functions. The details are as follows:

S110: displaying a text selection menu according to current display location information of a text content on a screen when a selection operation for the text content in a current view control is detected.

In this embodiment, the view control may be a view control currently displayed on the screen for carrying text content, including but not limited to a web view control and a text view control. The selection operation for the text content in the current view control may be, for example, an operation in which the user clicks to select a piece of text content in the view control currently displayed on the screen.

The text selection menu may include options such as copy, paste, and forward, which may be displayed near the selected text content. Exemplarily, a menu display area may be drawn at a location near the current display location of the selected text content, so that the text selection menu is displayed within the range of the menu display area. For example, the menu display area can be drawn above the current display location area of the first word in the selected text content. Exemplarily, when the user triggers to select a piece of text content in the view control currently displayed on the mobile phone screen, the mobile phone will detect the selection operation and acquire the current display location information of the selected piece of text content on the screen. Above the location area corresponding to the display location information, the menu display area is drawn and the text selection menu is displayed in this area.

S120: acquiring the final display location information of the text content on the screen after a sliding operation completes, in response to detecting the sliding operation for the view control.

In this embodiment, the sliding operation for the view control may be a gesture sliding operation performed by the user on the screen display area corresponding to the view control. Specifically, the sliding operation for the view control may be detected by calling an event monitoring function. When a sliding operation for a view control is detected, it is first determined that whether the sliding operation completes. If it is determined that the sliding operation completes, that is, the sliding stops, the final display location information of the selected text content on the screen is acquired, wherein, the way of acquiring the final display location information may vary according to the type of view control.

The purpose of acquiring the final display location information of the text content on the screen is to determine the location of the selected text content after the sliding operation completes, so as to redisplay the text selection menu near the location.

S130: redisplaying the text selection menu according to the final display location information.

In the prior art, once the text selection menu is displayed, the text selection menu cannot be redisplayed unless the text content is reselected. Therefore, when the user selects the text content, if the user makes a misoperation on the view control to perform a sliding operation, there will be a problem that the selected text content is removed when sliding the view control, and the text selection menu disappears.

In this embodiment, after the sliding operation completes, the location information of the selected text content is re-acquired, so that the text selection menu is redisplayed according to the location information, and it is realized that the location of the text selection menu corresponding to the selected text content on the screen moves with the movement of the selected text content, so that the text selection menu is always displayed around the selected text content, which is convenient for users to operate the menu and improves the interactivity of the text selection menu.

Optionally, the step of redisplaying the text selection menu according to the final display location information includes: redrawing a menu display area at the corresponding location of the final display location information by calling a preset redrawing function, and displaying the content of the text selection menu in the menu display area.

The preset redrawing function may be a function used by the operating system to draw the menu display area, for example, the InvalidateContentRect method corresponding to ActionMode in Android. Exemplarily, for the WebView control, the InvalidateContentRect method of ActionMode can be called to redraw the menu display area at the location corresponding to the final display location information, where the redraw menu display area can be above the final display location area of the selected text content, or below the final display location area of the selected text content, or can also be the blank location closest to the final display location area of the selected text content, etc., which is not limited here. At the same time, the previously displayed text selection menu is deleted, and the text selection menu is redisplayed in the menu display area, so that the text selection menu is always displayed around the selected text content.

In the technical solution of this embodiment, the final display location information on the screen of the selected text content after the sliding operation completes is acquired, after detecting the sliding operation for the current view control, and the text selection menu according to the final display location information is displayed. This solves the problem that the text selection menu displayed corresponding to the selected text content disappears in the prior art due to user misoperation and other reasons, which causes the interactivity of the text selection menu to decrease, and realizes that the location of the text selection menu on the screen corresponding to the selected text content moves with the movement of the selected text content, and the text selection menu is always displayed around the selected text content, thereby improving the interactivity of the text selection menu.

### Embodiment 2

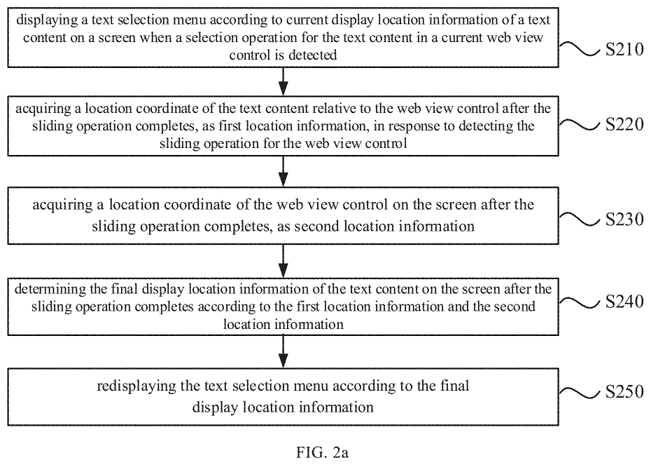

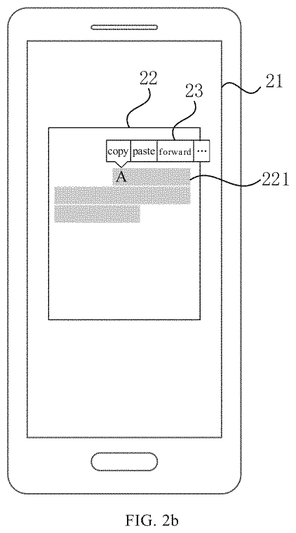

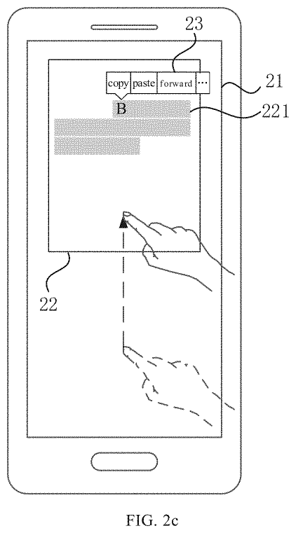

FIG. 2a is a schematic flowchart of a menu display method provided in one or more embodiments of the present disclosure. This embodiment is embodied on the basis of various optional solutions in the foregoing embodiment, and provides an optional menu display method. Specifically, the view control may include a web view control. And the method can specifically include the following:

S210: displaying a text selection menu according to current display location information of a text content on a screen when a selection operation for the text content in a current view control is detected.

S220: acquiring a location coordinate of the text content relative to the web view control after the sliding operation completes, as first location information, in response to detecting the sliding operation for the web view control.

In this embodiment, the web view control may be, for example, a WebView control. The sliding operation for the web view control may be a gesture sliding operation performed by the user on the screen display area corresponding to the web view control.

After a sliding operation completes, the locations of the text content and the web view control can be changed in the following two situations: the location of the web view control on the screen changes, and the selected text content relative to the location of the web view control does not change; or, the selected text content relative to the location of the web view control changes, but the location of the web view control on the screen does not change.

In either case, after the sliding operation completes, the final display location information of the selected text content on the screen is determined by acquiring the location coordinates of the selected text content relative to the web view control and the location coordinates of the web view control on the screen.

Optionally, the step of acquiring a location coordinate of the text content relative to the web view control after the sliding operation completes, as first location information includes: sending a location acquiring request to a web browser where the web view control is located after the sliding operation completes, wherein the location acquiring request is used to acquire a location coordinate of a selected text content in the web view control relative to the web view control; receiving the location coordinate of the selected text content returned by the web browser relative to the web view control after the sliding operation completes, and using the location coordinate as the first location information.

Exemplarily, for the WebView control, the client can send a request message to the web browser corresponding to the WebView control through a js call, that is, a location acquiring request, so that the web browser determines the coordinates of the starting text in the selected text content relative to the slided WebView control after receiving the request, and the coordinates are returned to the client. After receiving the coordinates, the client uses the coordinates as the first location information.

S230: acquiring a location coordinate of the web view control on the screen after the sliding operation completes, as second location information.

Wherein, the second location information can be acquired by calling the preset location acquisition function of the system. For example, the start point coordinates (that is, the upper left corner coordinates) of the slided WebView control on the screen can be acquired by calling the getLocationOnScreen method provided by the View class in Android, as the second location information.

S240: determining the final display location information of the text content on the screen after the sliding operation completes according to the first location information and the second location information.

Exemplarily, on the basis of the relative location of the starting text of the selected text content in the web view control, that is, the first location information, the coordinates of the starting point of the web view control on the screen can be used as the offset, the current display location of the selected text content is corrected to obtain the final display location of the selected text content on the screen.

Optionally, the step of determining final display location information of the text content on the screen after the sliding operation completes according to the first location information and the second location information includes: adding the first location information to the second location information to obtain the final display location information of the text content on the screen after the sliding operation completes.

Exemplarily, for the WebView control, the specific correction method may be that the first location information is added to the second location information to obtain the final display location information. For example, as shown in FIG. 2b, in the coordinate system established with the upper left corner of the screen 21 as the origin, and the rightwards and downwards directions of the x-axis and y-axis as positive directions, respectively, if the location coordinates of the WebView control 22 on the screen 21 before the sliding operation (that is, the second location information) is (1, 4), the location coordinates of the starting text in the selected text content 221 in the WebView control 22 relative to the WebView control 22 is (3, 5), and the corresponding text selection menu 23 is displayed above the location. When it is determined that the acquired location coordinates of the starting text in the selected text content 221 relative to the WebView control 22 (that is, the first location information) is (3, 5) and the location coordinates of the WebView control 22 on the screen 21 (that is, the second location information) is (1, 1) after the sliding operation completes (as shown in FIG. 2c), the final display location coordinate B of the starting text in the selected text content 221 on the screen 21 is (4, 6), and the final display location coordinate B (4, 6) is determined as the final display location of the selected text content 221 in the screen 21 after the sliding operation completes, and then the corresponding text selection menu 23 is redisplayed above the location.

S250: redisplaying the text selection menu according to the final display location information.

In the technical solution of this embodiment, by detecting the sliding operation for the web view control, acquiring a location coordinate of the selected text content relative to the web view control after the sliding operation completes, as first location information, acquiring a location coordinate of the web view control on the screen after the sliding operation completes, as second location information, combining the first location information and the second location information to determine the final display location information of the selected text content on the screen after the sliding operation completes, and redisplaying the text selection menu according to the final display location information. It is realized that the location of the text selection menu on the screen corresponding to the selected text content in the web view control moves with the movement of the selected text content, and the text selection menu is always displayed around the selected text content, thereby improving the interactivity of the text selection menu.

### Embodiment 3

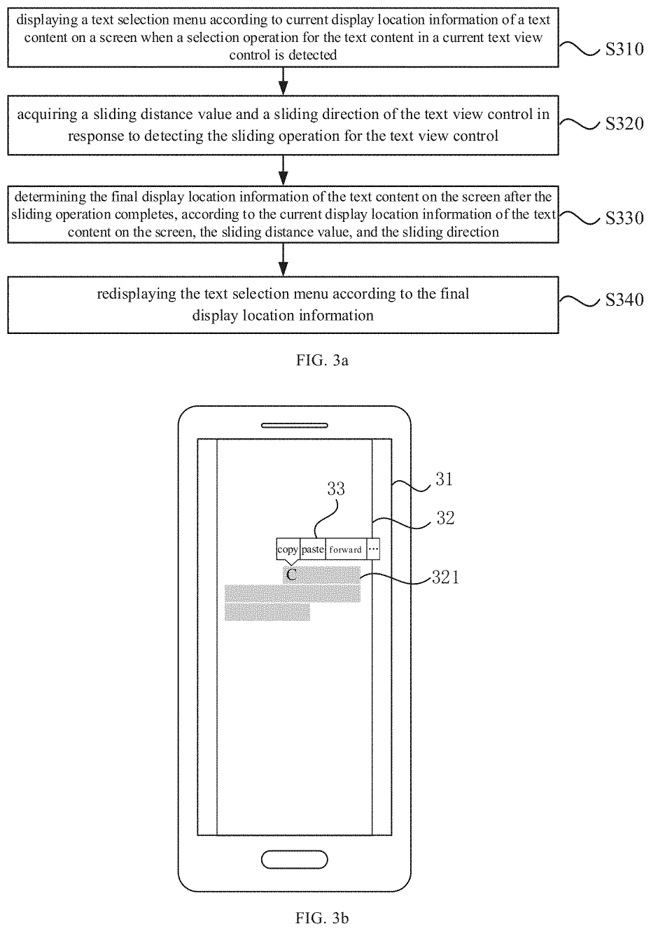

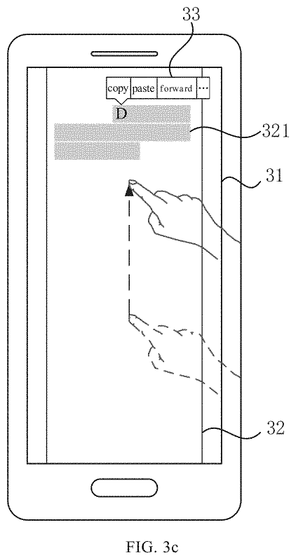

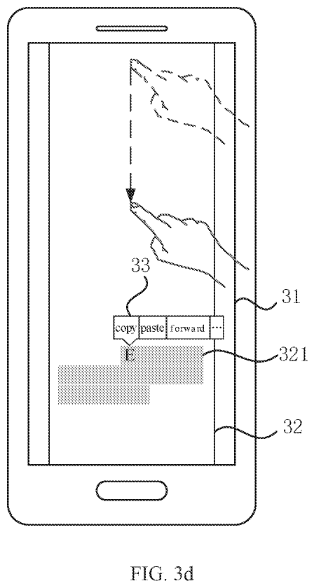

FIG. 3a is a schematic flowchart of a menu display method provided in one or more embodiments of the present disclosure. This embodiment is embodied on the basis of the various optional solutions in the foregoing embodiment, and provides an optional menu display method.

Specifically, the view control includes: a text view control. The details are as follows:

S310: displaying a text selection menu according to current display location information of a text content on a screen when a selection operation for the text content in a current text view control is detected.

S320: acquiring a sliding distance value and a sliding direction of the text view control in response to detecting the sliding operation for the text view control.

In this embodiment, the text view control may be, for example, a TextView control in Android. The sliding operation for the text view control may be a gesture sliding operation performed by the user on the screen display area corresponding to the text view control. Exemplarily, the sliding operation for the text view control can be detected by calling the event monitoring function, including obtaining the sliding distance value and the sliding direction of the text view control. The sliding operation may include an upward sliding operation and a downward sliding operation. Correspondingly, the acquired sliding direction of the text view control may include an upward sliding and a downward sliding. The sliding distance value is the distance value for the text in the text view control to slide up or down.

S330: determining the final display location information of the text content on the screen after the sliding operation completes, according to the current display location information of the text content on the screen, the sliding distance value, and the sliding direction.

Wherein, different calculation formulas can be correspondingly set for different sliding directions. Exemplarily, according to the sliding direction, the current display location information of the text content on the screen and the obtained sliding distance value can be substituted into preset calculation formulas in different directions, and the final display location information of the text content on the screen after the sliding operation completes is calculated.

Optionally, the step of determining the final display location information of the text content on the screen after the sliding operation completes, according to the current display location information of the text content on the screen, the sliding distance value, and the sliding direction includes: if it is determined that the sliding direction is sliding upward, the sliding distance value is subtracted from a vertical coordinate value included in the current display location information of the text content on the screen to obtain a final vertical coordinate value of the text content on the screen, and a horizontal coordinate value included in the current display location information is used as a final horizontal coordinate value of the text content on the screen; if it is determined that the sliding direction is a downward sliding, the sliding distance value is added to the vertical coordinate value included in the current display location information of the text content on the screen to obtain the final vertical coordinate value of the text content on the screen, and the horizontal coordinate value included in the current display location information is used as the final horizontal coordinate value of the text content on the screen; and the final vertical coordinate value and the final horizontal coordinate value is determined as the final display location information of the text content on the screen after the sliding operation completes.

For example, as shown in FIG. 3b, for the TextView control 32, in the coordinate system established with the upper left corner of the screen 31 as the origin, and the rightwards and downwards directions of the x-axis and y-axis as positive directions, respectively, if the current display location coordinate of the selected text content 321 on the screen 31 is C(3,5), the corresponding text selection menu 33 is displayed above the location, then when it is determined that the sliding direction is sliding upwards (as shown in FIG. 3c) and the sliding distance value is 3, the final display location coordinate of the selected text content 321 in the TextView control 32 on the screen 31 is D (3, 2), and the final display location coordinate D (3, 2) is determined as a final display location information of the selected text content 321 on the screen 31 after the sliding operation completes, and then the corresponding text selection menu 33 is redisplayed above the location; when the sliding direction is determined to be sliding downward (as shown in FIG. 3d), and the sliding distance value is 3, the final display location coordinate of the selected text content 321 in the TextView control 32 on the screen 31 is E (3, 8), and the final display location coordinate E (3, 8) is determined as a final display location information of the selected text content 321 on the screen 31 after the sliding operation completes, and the corresponding text selection menu 33 is redisplayed above the location.

S340: redisplaying the text selection menu according to the final display location information.

Exemplarily, if all the selected text content is displayed on the screen after the sliding operation completes, the redraw menu display area may be above or below the final display location area of the selected text content, or at its nearest blank location; if only part of the selected text content is displayed on the screen after the sliding operation completes, when the sliding operation is an upward sliding, the redraw menu display area can be below the final display location area of the last line of the selected text content, when the sliding operation is a downward sliding, the redraw menu display area can be above the final display location area of the last line of the selected text content; if all of the selected text content disappear and do not display on the screen after the sliding operation completes, the text selection menu is not displayed.

In the technical solution of this embodiment, it acquires the sliding distance value and the sliding direction of the text view control by detecting the sliding operation for the text view control, and then combines the current display location information of the selected text content on the screen to determine the final display location information of the text content on the screen after the sliding operation completes, and redisplay the text selection menu according to the final location information. It is realized that the location of the text selection menu on the screen corresponding to the selected text content in the web view control moves with the movement of the selected text content, and the text selection menu is always displayed around the selected text content, thereby improving the interactivity of the text selection menu.

On the basis of the foregoing embodiment, as an alternative step of S320-S330, optionally, it is also possible to obtain the final display location information of the text content on the screen after the sliding operation completes by calling a preset screen location acquisition function.

Exemplarily, for the TextView control, since the TextView control is a local control in Android, the location coordinates of the selected text content on the screen can be easily obtained at any time. Specifically, the final location coordinates of the starting text on the screen in the selected text content after the sliding operation can directly be obtained by calling the preset screen location acquisition function, such as the getLocationOnScreen function provided by the View class in Android, as the final display location information of the text content on the screen.

### Embodiment 4

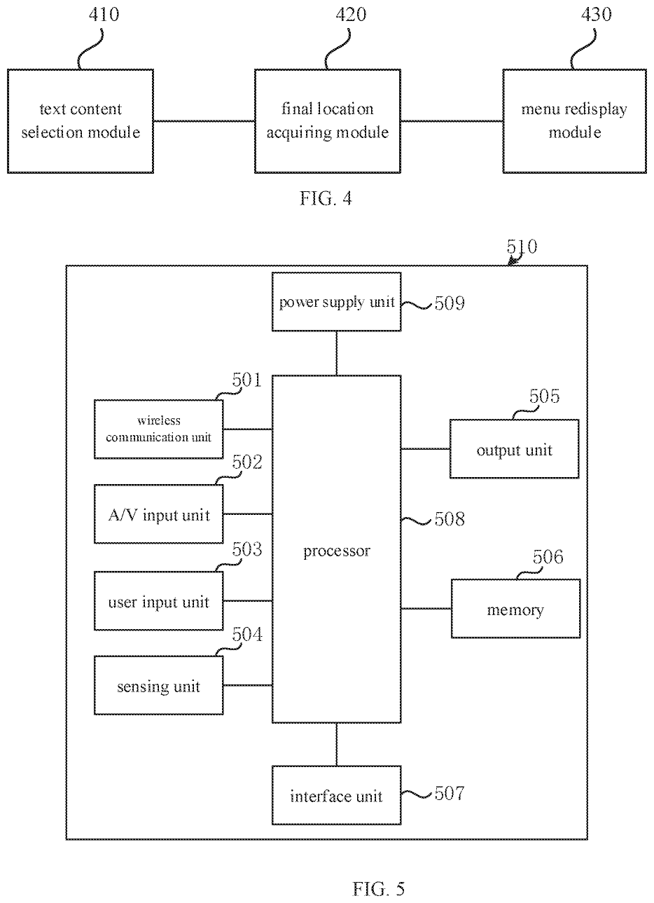

FIG. 4 is a schematic structural diagram of a menu display apparatus provided in one or more embodiments of the present disclosure. Referring to FIG. 3, the menu display apparatus includes: a text content selection module 410, a final location acquiring module 420, and a menu redisplay module 430. Each module will be described in detail below.

The text content selection module 410 is configured to display a text selection menu according to current display location information of a text content on a screen when a selection operation for the text content in a current view control is detected.

The final location acquiring module 420 is configured to obtain the final display location information of the text content on the screen after a sliding operation completes, in response to detecting the sliding operation for the view control.

The menu redisplay module 430 is configured to redisplay the text selection menu according to the final display location information.

The menu display apparatus provided in this embodiment obtains the final display location information of the selected text content on the screen after the sliding operation completes, by detecting the sliding operation for the current view control, and displays the text according to the final display location information. This solves the problem that the text selection menu displayed corresponding to the selected text content disappears in the prior art due to user misoperation and other reasons, which causes the interactivity of the text selection menu to decrease, and realizes that the location of the text selection menu on the screen corresponding to the selected text content moves with the movement of the selected text content, and the text selection menu is always displayed around the selected text content, thereby improving the interactivity of the text selection menu.

Optionally, the view control may include a web view control.

The final location acquiring module 420 may include:

a first location acquiring submodule configured to acquire a location coordinate of the text content relative to the web view control after the sliding operation completes, as first location information;

a second location acquiring submodule configured to acquire a location coordinate of the web view control on the screen after the sliding operation completes, as second location information;

a location information determining submodule configured to determine the final display location information of the text content on the screen after the sliding operation completes according to the first location information and the second location information.

Optionally, the first location acquiring submodule may specifically:

send a location acquiring request to a web browser where the web view control is located after the sliding operation completes, wherein the location acquiring request is used to acquire a location coordinate of a selected text content in the web view control relative to the web view control; and receive the location coordinate of the text content returned by the web browser relative to the web view control after the sliding operation completes, and using the location coordinate as the first location information.

Optionally, the location information determining submodule may:

add the first location information to the second location information to obtain the final display location information of the text content on the screen after the sliding operation completes.

Optionally, the view control may include a text view control.

The final location acquiring module 420 may include:

a distance direction acquiring submodule configured to acquire a sliding distance value and sliding direction of the text view control; a display location determining submodule configured to determine the final display location information of the text content on the screen after the sliding operation completes, according to the current display location information of the text content on the screen, the sliding distance value, and the sliding direction; or,

a display location acquiring submodule configured to obtain the final display location information of the text content on the screen after the sliding operation completes by calling a preset screen location acquisition function.

Optionally, the display location determining submodule may:

subtract the sliding distance value from a vertical coordinate value included in the current display location information of the text content on the screen to obtain a final vertical coordinate value of the text content on the screen, and use a horizontal coordinate value included in the current display location information as a final horizontal coordinate value of the text content on the screen, if it is determined that the sliding direction is sliding upward;

add the sliding distance value to the vertical coordinate value included in the current display location information of the text content on the screen to obtain the final vertical coordinate value of the text content on the screen, and use the horizontal coordinate value included in the current display location information as the final horizontal coordinate value of the text content on the screen, if it is determined that the sliding direction is a downward sliding;

determine the final vertical coordinate value and the final horizontal coordinate value as the final display location information of the text content on the screen after the sliding operation completes.

Optionally, the menu redisplay module 430 may redraw a menu display area at the corresponding location of the final display location information by calling a preset redrawing function, and displaying the content of the text selection menu in the menu display area.

The above-mentioned product can execute the method provided in any embodiment of the present disclosure, and has corresponding functional modules and beneficial effects for executing the method.

### Embodiment 5

FIG. 5 is a schematic diagram of a hardware structure of a terminal device provided in one or more embodiments of the present disclosure. Terminal devices can be implemented in various forms.

The terminal devices in the present disclosure can include, but are not limited to, mobile phones, smart phones, notebook computers, digital broadcast receivers, personal digital assistants PDAs, tablet computers (PADs), and Portable multimedia players (PMPs), navigation apparatus, vehicle-mounted terminal device, vehicle-mounted display terminals, vehicle-mounted electronic rear-view mirrors, and other mobile terminal equipment, and fixed terminal equipment such as digital TVs, desktop computers, etc.

As shown in FIG. 5, the terminal device 510 may include a wireless communication unit 501, an A/V (audio/video) input unit 502, a user input unit 503, a sensing unit 504, an output unit 505, a memory 506, an interface unit 507, a processor 508 and a power supply unit 509 and so on. FIG. 5 illustrates a terminal device with various components, but it should be understood that implementation of all the illustrated components is not required. More or fewer components can be implemented instead.

Wherein, the wireless communication unit 501 allows radio communication between the terminal device 510 and a wireless communication system or network. The A/V input unit 502 is used to receive audio or video signals. The user input unit 503 may generate key input data according to commands input by the user to control various operations of the terminal device. The sensing unit 504 detects the current state of the terminal device 510, the location of the terminal device 510, the presence or absence of the user's touch input to the terminal device 510, the orientation of the terminal device 510, the acceleration or deceleration movement and direction of the terminal device 510, etc., and generates a command or signal for controlling the operation of the terminal device 510. The interface unit 507 serves as an interface through which at least one external device can be connected to the terminal device 510. The output unit 505 is configured to provide output signals in a visual, audio, and/or tactile manner. The memory 506 may store software programs for processing and control operations executed by the processor 508, etc., or may temporarily store data that has been output or will be output. The memory 506 may include at least one type of storage medium. Moreover, the terminal device 510 may cooperate with a network storage device that performs the storage function of the memory 506 through a network connection. The processor 508 generally controls the overall operation of the terminal device. In addition, the processor 508 may include a multimedia module for reproducing or playing back multimedia data. The processor 508 may perform pattern recognition processing to recognize handwriting input or picture drawing input performed on the touch screen as characters or images. The power supply unit 509 receives external power or internal power under the control of the processor 508 and provides appropriate power required to operate various elements and components.

The processor 508 executes various functional applications and data processing by running programs stored in the memory 506, for example, to implement a menu display method provided by an embodiment of the present disclosure. The method may specifically include: displaying a text selection menu according to current display location information of a text content on a screen when a selection operation for the text content in a current view control is detected; acquiring the final display location information of the text content on the screen after a sliding operation completes, in response to detecting the sliding operation for the view control; and redisplaying the text selection menu according to the final display location information.

### Embodiment 6

The embodiment 6 of the present disclosure further provides a computer-readable storage medium on which a computer program is stored. When the program is executed by the menu display apparatus, the menu display method as provided in one or more embodiments of the present disclosure is implemented, and the method includes: displaying a text selection menu according to current display location information of a text content on a screen when a selection operation for the text content in a current view control is detected; acquiring the final display location information of the text content on the screen after a sliding operation completes, in response to detecting the sliding operation for the view control; and redisplaying the text selection menu according to the final display location information.

The computer-readable storage medium provided by the embodiment of the present disclosure is not limited to the implementation of the method operation described above when the computer program stored thereon is executed, and related operations in the menu display method provided by any embodiment of the present disclosure can also be implemented.

Through the above description of the embodiments, those skilled in the art can clearly understand that the present disclosure can be implemented by software and necessary general-purpose hardware, of course, it can also be implemented by hardware, but in many cases the former is a better implementation. Based on this understanding, the technical solution of the present disclosure can be embodied in the form of a software product, which can be stored in a computer readable storage medium, such as a computer floppy disk, Read-Only Memory (ROM), Random Access Memory (RAM), flash, hard disk or optical disk, etc., including a number of instructions to make a computer device (may be a personal computer, a server, or a network device, etc.) to execute the method described in each embodiment of the present disclosure.

It is worth noting that in the above embodiment of the menu display apparatus, the various units and modules included are only divided according to the functional logic, but are not limited to the above division, as long as the corresponding functions can be realized. In addition, each specific names of the functional units are only for easy distinction, and are not used to limit the protection scope of the present disclosure.

Note that the above are only the preferred embodiments of the present disclosure and the technical principles applied. Those skilled in the art will understand that the present disclosure is not limited to the specific embodiments described herein, and various obvious changes, readjustments and substitutions can be made to those skilled in the art without departing from the protection scope of the present disclosure. Therefore, although the present disclosure has been described in more detail through the above embodiments, the present disclosure is not limited to the above embodiments, and may also include more other equivalent embodiments without departing from the concept of the present disclosure, and the scope of the present disclosure is determined by the scope of the appended claims.

1. A menu display method, comprising the following steps of:
displaying a text selection menu according to current display location information of a text content on a screen when a selection operation for the text content in a current view control is detected;
acquiring the final display location information of the text content on the screen after a sliding operation completes, in response to detecting the sliding operation for the view control; and
redisplaying the text selection menu according to the final display location information.

2. The menu display method according to claim 1, wherein the view control comprises a web view control, and
the step of acquiring the final display location information of the text content on the screen after a sliding operation completes comprises:
acquiring a location coordinate of the text content relative to the web view control after the sliding operation completes, as first location information;
acquiring a location coordinate of the web view control on the screen after the sliding operation completes, as second location information; and
determining the final display location information of the text content on the screen after the sliding operation completes according to the first location information and the second location information.

3. The menu display method according to claim 2, wherein the step of acquiring a location coordinate of the text content relative to the web view control after the sliding operation completes, as first location information comprises:
sending a location acquiring request to a web browser where the web view control is located after the sliding operation completes, wherein the location acquiring request is used to acquire a location coordinate of a selected text content in the web view control relative to the web view control; and
receiving the location coordinate of the text content returned by the web browser relative to the web view control after the sliding operation completes, and using the location coordinate as the first location information.

4. The menu display method according to claim 2, wherein the step of determining the final display location information of the text content on the screen after the sliding operation completes according to the first location information and the second location information comprises:
adding the first location information to the second location information to obtain the final display location information of the text content on the screen after the sliding operation completes.

5. The menu display method according to claim 1, wherein the view control comprises a text view control, and
the step of acquiring the final display location information of the text content on the screen after the sliding operation completes comprises:
acquiring a sliding distance value and sliding direction of the text view control; and
determining the final display location information of the text content on the screen after the sliding operation completes, according to the current display location information of the text content on the screen, the sliding distance value, and the sliding direction; or
acquiring the final display location information of the text content on the screen after the sliding operation completes by calling a preset screen location acquisition function.

6. The menu display method according to claim 5, wherein the step of determining the final display location information of the text content on the screen after the sliding operation completes, according to the current display location information of the text content on the screen, the sliding distance value, and the sliding direction comprises:
subtracting the sliding distance value from a vertical coordinate value included in the current display location information of the text content on the screen to obtain a final vertical coordinate value of the text content on the screen, and using a horizontal coordinate value included in the current display location information as the final horizontal coordinate value of the text content on the screen, if it is determined that the sliding direction is sliding upward;
adding the sliding distance value and the vertical coordinate value included in the current display location information of the text content on the screen to obtain the final vertical coordinate value of the text content on the screen, and using the horizontal coordinate value included in the current display location information as the final horizontal coordinate value of the text content on the screen, if it is determined that the sliding direction is sliding downward; and
determining the final vertical coordinate value and the final horizontal coordinate value as the final display location information of the text content on the screen after the sliding operation completes.

7. The menu display method according to claim 1, wherein the step of redisplaying the text selection menu according to the final display location information comprises:
redrawing a menu display area at the corresponding location of the final display location information by calling a preset redrawing function, and displaying the content of the text selection menu in the menu display area.

8. A terminal device, comprising:
one or more processors;
a memory configured to store one or more programs;
the one or more programs are executed by the one or more processors, so that the one or more processors implement a menu display method, wherein the method comprises:
displaying a text selection menu according to current display location information of a text content on a screen when a selection operation for the text content in a current view control is detected;
acquiring the final display location information of the text content on the screen after a sliding operation completes, in response to detecting the sliding operation for the view control; and
redisplaying the text selection menu according to the final display location information.

9. A computer-readable storage medium storing computer program, where the computer program, when being executed by a processor, causes to implement a menu display method, wherein the method comprises:
displaying a text selection menu according to current display location information of a text content on a screen when a selection operation for the text content in a current view control is detected;
acquiring the final display location information of the text content on the screen after a sliding operation completes, in response to detecting the sliding operation for the view control; and
redisplaying the text selection menu according to the final display location information.

10. The computer-readable storage medium according to claim 9, wherein the view control comprises a web view control, and
the step of acquiring the final display location information of the text content on the screen after a sliding operation completes comprises:
acquiring a location coordinate of the text content relative to the web view control after the sliding operation completes, as first location information;
acquiring a location coordinate of the web view control on the screen after the sliding operation completes, as second location information; and
determining the final display location information of the text content on the screen after the sliding operation completes according to the first location information and the second location information.

11. The computer-readable storage medium according to claim 10, wherein the step of acquiring a location coordinate of the text content relative to the web view control after the sliding operation completes, as first location information comprises:
sending a location acquiring request to a web browser where the web view control is located after the sliding operation completes, wherein the location acquiring request is used to acquire a location coordinate of a selected text content in the web view control relative to the web view control; and
receiving the location coordinate of the text content returned by the web browser relative to the web view control after the sliding operation completes, and using the location coordinate as the first location information.

12. The computer-readable storage medium according to claim 10, wherein the step of determining the final display location information of the text content on the screen after the sliding operation completes according to the first location information and the second location information comprises:
adding the first location information to the second location information to obtain the final display location information of the text content on the screen after the sliding operation completes.

13. The computer-readable storage medium according to claim 9, wherein the view control comprises a text view control, and
the step of acquiring the final display location information of the text content on the screen after the sliding operation completes comprises:
acquiring a sliding distance value and sliding direction of the text view control; and
determining the final display location information of the text content on the screen after the sliding operation completes, according to the current display location information of the text content on the screen, the sliding distance value, and the sliding direction; or
acquiring the final display location information of the text content on the screen after the sliding operation completes by calling a preset screen location acquisition function.

14. The computer-readable storage medium according to claim 13, wherein the step of determining the final display location information of the text content on the screen after the sliding operation completes, according to the current display location information of the text content on the screen, the sliding distance value, and the sliding direction comprises:
subtracting the sliding distance value from a vertical coordinate value included in the current display location information of the text content on the screen to obtain a final vertical coordinate value of the text content on the screen, and using a horizontal coordinate value included in the current display location information as the final horizontal coordinate value of the text content on the screen, if it is determined that the sliding direction is sliding upward;
adding the sliding distance value and the vertical coordinate value included in the current display location information of the text content on the screen to obtain the final vertical coordinate value of the text content on the screen, and using the horizontal coordinate value included in the current display location information as the final horizontal coordinate value of the text content on the screen, if it is determined that the sliding direction is sliding downward; and
determining the final vertical coordinate value and the final horizontal coordinate value as the final display location information of the text content on the screen after the sliding operation completes.

15. The computer-readable storage medium according to claim 9, wherein the step of redisplaying the text selection menu according to the final display location information comprises:
redrawing a menu display area at the corresponding location of the final display location information by calling a preset redrawing function, and displaying the content of the text selection menu in the menu display area.
